(19) United States
(12) Patent Application Publication
(10) Pub. No.: US 2018/0116137 A1
(43) Pub. Date: May 3, 2018

(54) DUAL-MEDIA HORTICULTURAL PLUG

(71) Applicant: Local Urban Vegetables, LLLP, Beverly Hills, CA (US)

(72) Inventors: Morris Gasmer, Beverly Hills, CA (US); Martin Boerema, Wausau, WI (US)

(21) Appl. No.: 15/645,993

(22) Filed: Jul. 10, 2017

Related U.S. Application Data
(60) Provisional application No. 62/360,237, filed on Jul. 8, 2016.

(51) Int. Cl. A01G 31/00; C05F 11/00

(52) U.S. Cl. CPC A01G 31/001; A01G 2031/003; A01G 9/1086; C05F 11/00

(57) ABSTRACT

A dual-media horticultural plug comprising a base having a substantially continuous bottom surface and a top surface spaced from the bottom surface, a sidewall extending from the base and forming an elongated inner cavity, a growing substrate substantially filling the elongated inner cavity, and a water-impermeable outer cover substantially covering an open top end of the elongated inner cavity. The growing substrate comprises a first growing medium having a first water holding capacity, and at least one of the base and the sidewall comprise a second growing medium having a second water holding capacity. The first water holding capacity is greater than the second water holding capacity.

### CROSS REFERENCE TO RELATED APPLICATION

This application claims the benefit of the filing date of U.S. Provisional Patent Application No. 62/360,237, filed on Jul. 8, 2016, the disclosure of which is incorporated by reference herein.

### FIELD OF THE INVENTION

This invention relates generally to a plant growing body and, more particularly, to a dual-media horticultural plug suitable for seeding machines and automated hydroponic and aeroponic growing systems.

### BACKGROUND

Conventional propagation seed plugs may not be sufficiently optimized for soilless growing systems and automated seeding and processing.

For example, such horticultural plugs generally may lack a unifomrm shape and size or may not maintain a sturdy and uniform shape when processed by automated seeding machines and other automated processes.

In addition, existing plugs may include a growing substrate that is not adapted to encourage directed root development and thereby facilitate a rapid transition from an ebb-and-flow environment of a nursery system to an environment of an aeroponic system. Moreover, some of the more friable substrates may drop particulates into a surrounding system and may not be adapted to maintain a sterile growth environment.

Moreover, when plants have grown to develop a canopy, a micro-climate within the canopy can develop from vapor evaporation from the growing substrate. This vapor evaporation can further contribute to algae growth and salt buildup within the canopy. These conditions can interfere with the plant's healthy development.

### BRIEF SUMMARY OF THE INVENTION

An embodiment in accordance with some aspects of the invention provides a dual-media horticultural plug comprising a base having a substantially continuous bottom surface and a top surface spaced from the bottom surface, a sidewall extending from the base and forming an elongated inner cavity, a growing substrate substantially filling the elongated inner cavity, and a water-impermeable outer cover substantially covering an open top end of the elongated inner cavity. The open top end of the elongated inner cavity is substantially defined by an inner surface of the sidewall and the top surface of the base. The outer cover extends over a top surface of the sidewall and down an outer surface of the sidewall toward the base, leaving the bottom surface of the base substantially uncovered. The growing substrate comprises a first growing medium having a first water holding capacity, and at least one of the base and the sidewall comprise a second growing medium having a second water holding capacity. The first water holding capacity of the first growing medium is greater than the second water holding capacity of the second growing medium.

In some embodiments, the first water holding capacity is at least about 70% by volume. In one embodiment, the second water holding capacity is no more than about 30% by volume. In another embodiment, the first and second growing media are hydrophilic. In an additional embodiment, the first growing medium includes capillary pores. In a further embodiment, the second growing medium includes non-capillary pores.

In some embodiments, the first growing medium has a first bulk density and the second growing medium has a second bulk density, and the first bulk density of the first growing medium is greater than the second bulk density of the second growing medium. In one embodiment, the first bulk density is from about 0.1 g/cm3 to about 0.6 g/cm3. In another embodiment, the second bulk density is from about 0.01 g/cm3 to about 0.1 g/cm3.

In some embodiments, the first growing medium is selected from the group consisting of coconut coir pith and reticulated foam. In one embodiment, the first growing medium comprises coconut coir pith. In another embodiment, the first growing medium comprises reticulated foam. In a further embodiment, the first growing medium comprises reticulated foam having a porosity from about 10 to about 20 pores per inch.

In some embodiments, the second growing medium is selected from the group consisting of coconut coir fiber and reticulated foam. In one embodiment, the second growing medium comprises coconut coir fiber. In another embodiment, the second growing medium comprises reticulated foam. In a further embodiment, the second growing medium comprises reticulated foam having a porosity of at least about 100 pores per inch.

In one embodiment, the dual-media horticultural plug further includes a seed within the growing substrate. In another embodiment, the elongated inner cavity extends from about 75% to about 95% of a depth defined between the top surface of the sidewall and the bottom surface of the base. In a further embodiment, the elongated inner cavity extends from about 15% to about 50% of a width defined by a perimeter of the sidewall. In an additional embodiment, the water-impermeable outer cover comprises a biodegradable film. In yet another embodiment, the water-impermeable outer cover is reflective.

These and other embodiments in accordance with aspects of the invention should become apparent from the following description of the preferred embodiments, taken in conjunction with the accompanying drawings, which illustrate, by way of example, the principles of the invention.

### BRIEF DESCRIPTION OF THE DRAWINGS

FIG. 1 is a top plan view of a horticultural plug in accordance with one embodiment of the present invention.

FIG. 2 is a top perspective view of a horticultural plug in accordance with one embodiment of the present invention.

FIG. 3 is a cross-sectional side view, taken along the line 3-3 in FIG. 2, of a horticultural plug in accordance with one embodiment of the present invention.

FIG. 4 is a bottom perspective view of a horticultural plug in accordance with one embodiment of the present invention.

FIG. 5 is a top plan view of a dual-media horticultural plug in accordance with one embodiment of the present invention.

FIG. 6 is a cross-sectional side view, taken along the line 6-6 in FIG. 5, of a dual-media horticultural plug in accordance with one embodiment of the present invention.

FIG. 7 is a top perspective view of a covered dual-media horticultural plug m accordance with one embodiment of the present invention.

FIG. 8 is a bottom perspective view of a covered dual-media horticultural plug in accordance with one embodiment of the present invention.

FIG. 9 is a top plan view of a covered dual-media horticultural plug in accordance with one embodiment of the present invention.

FIG. 10 is a cross-sectional side view, taken along the line 10-10 in FIG. 9, of a covered dual-media horticultural plug in accordance with one embodiment of the present invention.

FIG. 11 is a cross-sectional side view of a covered dual-media horticultural plug and plant in accordance with one embodiment of the present invention.

FIG. 12 and FIG. 13 illustrate use of a plug in an automated seeding process.

### DETAILED DESCRIPTION OF THE PREFERRED EMBODIMENTS

Some embodiments provide a dual media horticultural plug. In some embodiments the dual media horticultural plug includes an outer layer including a first type of a material and an inner layer including a second type of a material, with the inner layer inset into the outer layer, and with the first type of material and the second type of material having different characteristics with respect to water transport and/or storage. In some such embodiments the first type of material and the second type of material are both reticulated foam. In some embodiments the outer layer includes, in addition to the first type of material, the second type of material as well. For example, in some embodiments the outer layer includes a base of the second type of material, with the inner layer in contact with the base, while sides of the outer layer are of the first type of material.

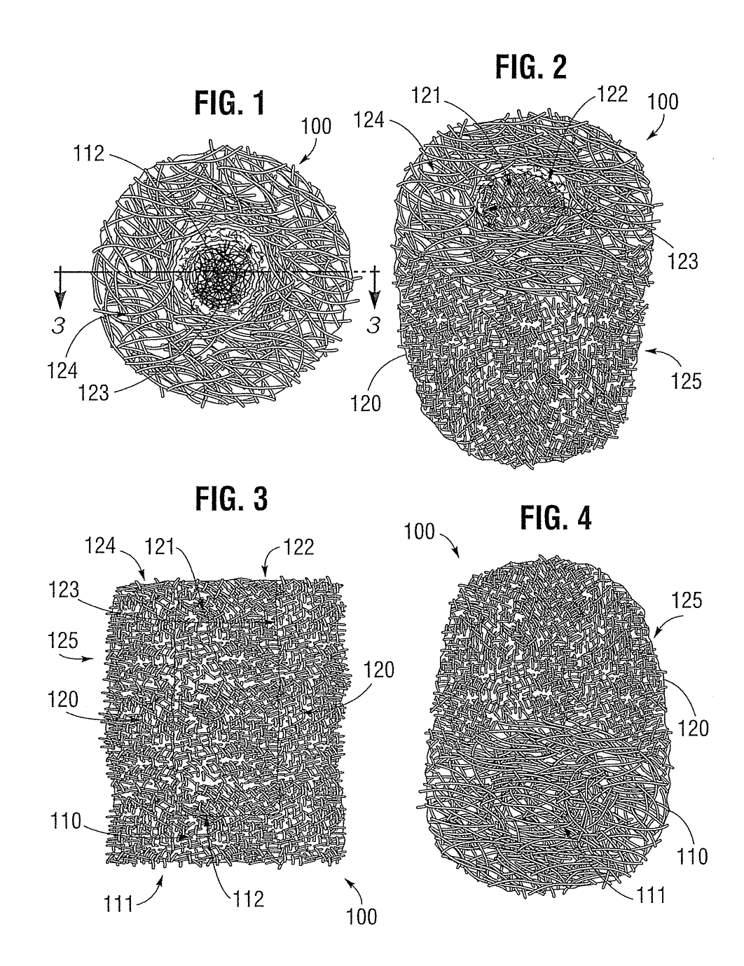

With reference now to the illustrative drawings, and particularly to FIG. 1-4, there is shown a horticultural plug 100 in accordance with one embodiment of the present invention. The plug includes a base 110 and a sidewall 120. The horticultural plug 100 includes an elongated inner cavity 121 to receive a growing substrate. In some embodiments the plug comprises reticulated foam, and in some embodiments the plug consists of reticulated foam. In some embodiments the reticulated foam has a porosity of at least 100 pores per inch. In some embodiments the plug comprises coconut coir fiber.

The base 110 has a substantially continuous bottom surface 111 and a top surface 112 spaced from the bottom surface. The substantially continuous bottom surface may include porous gaps, pores, or openings inherent to the material forming the base. In some embodiments, the base does not include drainage holes or other material interruptions to the whole.

The sidewall 120 extends from the base 110 and forms the elongated inner cavity 121. The elongated inner cavity may be configured to receive a growing medium, for example. An open top end 122 of the elongated inner cavity is substantially defined by an inner surface 123 of the sidewall 120 and the top surface 112 of the base 110. In one embodiment, the elongated inner cavity 121 extends from about 75% to about 95% of a depth defined between the top surface 124 of the sidewall 120 and the bottom surface 111 of the base 110. In a further embodiment, the elongated inner cavity 121 extends from about 15% to about 50% of a width defined by a perimeter of the sidewall 120.

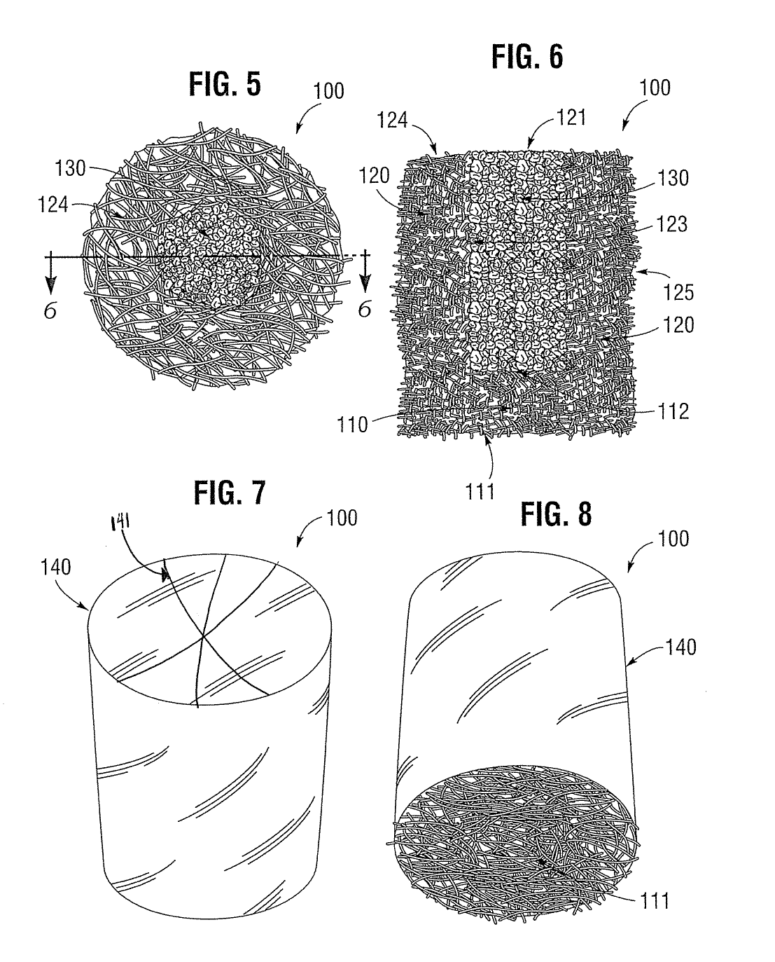

With reference now to FIGS. 5 and 6, a growing substrate 130 substantially fills the elongated inner cavity 121 to produce an embodiment of a dual-media horticultural plug 100. The dual-media horticultural plug, in some embodiments and as illustrated in FIGS. 5 and 6, includes the horticultural plug of FIGS. 1-4. In addition, the growing substrate 130 is at least partially within, and in some embodiments completely within, the elongated inner cavity 121. The growing substrate 130 comprises a first growing medium. In one embodiment, the first growing medium physically supports the plant, allows for root growth; and supplies roots with nutrients, air, and water. In another embodiment, the first growing medium can be a relatively inert medium that does not have a role as soil or contribute nutrition to the plant, but anchors the roots and acts as a momentary reserve for water and solvent mineral nutrients.

Roots grow into the spaces between individual particles of the first growing medium. Water also travels through these pore spaces due to gradients in water content and potentials, and is held in pores by cohesive and adhesive capillary forces. The ability of pores to conduct water is controlled mainly by the size and distribution of pores in the first growing medium. Pore sizes can be classified into non-capillary (macro) pores, coarse capillary pores, and fine capillary pores. Non- capillary pores drain rapidly, while capillary pores drain slowly or are water holding. Thus, downward water flow occurs principally through non-capillary pores, while the redistribution and lateral and upward flow occurs in capillary pores. In one embodiment, the pressure head corresponding with the cutoff between capillary and non-capillary pores is 10 kPa. In another embodiment, the first growing medium includes capillary pores.

In one embodiment, the first growing medium is selected from the group consisting of coconut coir pith and reticulated foam. Reticulated foam is a low density, open-cell solid foam. The solid component of a reticulated foam can be an organic polymer such as polyurethane. Reticulated polyurethane foam is light-weight and may be pathogen-resistant and/or disease-resistant. In one embodiment, the first growing medium comprises coconut coir pith. In another embodiment, the first growing medium comprises reticulated foam. In a further embodiment, the first growing medium comprises reticulated foam having a porosity from about 10 to about 20 pores per inch. In some embodiments the reticulated foam of the first growing medium is different than the reticulated foam of the sidewall and/or base of the horticultural plug 100. In some embodiments the reticulated foam of the first growing medium has a porosity greater than a porosity of the sidewall and/or base of the horticultural plug 100.

In some embodiments, the first growing medium has a first water holding capacity. Water holding capacity generally reflects the amount of water a growing medium can hold. Water holding capacity can vary with the texture of the growing media. For example, medium textured growing media generally exhibit higher water holding capacities, while coarse growing media generally exhibit lower water holding capacities. In one embodiment, water holding capacity is measured using the ⅓ Bar method, which is commonly referred to as field capacity. In another embodiment, the first water holding capacity is at least about 70% by volume.

In a further embodiment, the first growing medium has a first bulk density. Bulk density generally reflects a growing medium's compaction and its ability to function for structural support, water and solute movement, and aeration. Bulk density is calculated as the dry weight of the growing medium divided by its total volume. The total volume of the growing medium is the combined volume of solids and pores, which may contain air or water, or both. In one embodiment, the first bulk density is from about 0.1 g/cm3 to about 0.6 g/cm3.

In some embodiments, at least one of the base 110 and the sidewall 120 comprise a second growing medium. In one embodiment, the second growing medium includes non-capillary pores. In a more detailed feature of the invention, the second growing medium is selected from the group consisting of coconut coir fiber and reticulated foam. In one embodiment, the second growing medium comprises coconut coir fiber. In another embodiment, the second growing medium comprises reticulated foam. In a further embodiment, the second growing medium comprises reticulated foam having a porosity of at least 100 pores per inch. Other potential materials for either the first growing medium or the second growing medium include bark, bark fines, compost, expanded clay pellets, fiberglass insulation, glass wool, gravel, lava rock, lignin, oasis cubes, peat moss, perlite, plastic particles, pumice, rockwool, sand, sawdust, sphagnum moss, sponge, vermiculite, and wood mulch.

In an additional embodiment, the second growing medium has a second water holding capacity, which is less than the first water holding capacity of the first growing medium. In one embodiment, the second water holding capacity is no more than about 30% by volume. In a further embodiment, the second growing medium has a second bulk density, which is less than the first bulk density of the first growing medium. In another embodiment, the second bulk density is from about 0.01 g/cm3 to about 0.1 g/cm3.

In some embodiments, the first growing medium has higher capillarity than the second growing medium. In some embodiments the second growing medium comprises non-capillary pores. Capillarity within the first growing medium may ensure water availability within the elongated inner cavity 121, while the surrounding second growing medium will remain relatively dry and, therefore, less attractive for root development. As a result, roots may primarily grow down along the elongated inner cavity 121 to protrude quickly from the bottom surface 111 of the base 110 of the plug 100. This directed root development may facilitate an earlier transition from an ebb and flow nursery to an aeroponic growing wall, where exposed roots will use aeroponic aerosol to absorb water and nutrients.

In some embodiments, the second growing medium may tend to be drier and less dense than the first growing medium. As a result, the second growing medium may help the plug 100 to maintain a consistent, sturdy, and unifom1 shape, making it better suited for automated seeding and processing. In addition, the second growing medium may help to preserve a sterile and clean environment outside the plug 100 by retaining the growing substrate 130 within the elongated inner cavity 121.

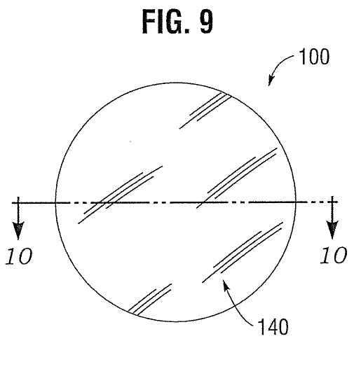

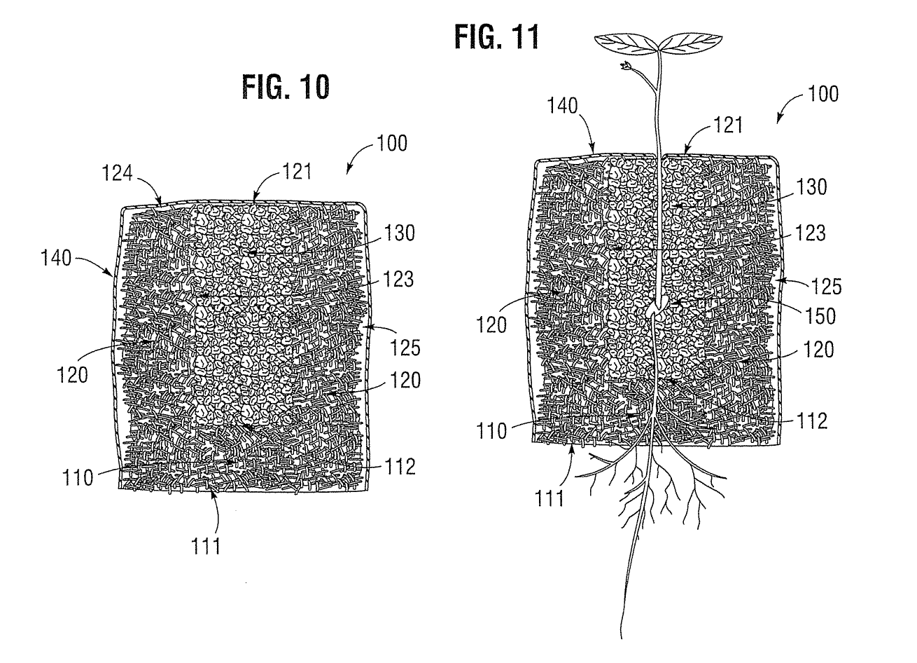

With reference now to FIGS. 7-10, in some embodiments a water-impermeable outer cover 140 substantially covers an open top end 122 of the elongated inner cavity 121 of the horticultural plug 100. The outer cover may include a hole, for example in a center of the top end, for insertion of a seed. In some embodiments the outer cover may instead include a slit or perforation in place of the hole. In some embodiments, and as illustrated in FIG. 7, the outer cover may include patterned perforations 141 across the top end. The patterned perforations may take a variety of shapes, for example asterisk or star-shaped. In some embodiments the patterned perforations include a plurality of lines and/or curves, which generally intersect about a center of the top end. In some embodiments, and as illustrated in FIG. 8, the outer cover 140 also extends over a top surface 124 of the sidewall 120 and down an outer surface 125 of the sidewall toward the base 110, leaving the bottom surface 111 of the base substantially uncovered. In some embodiments the outer cover only partially extends down the outer surface of the sidewall. In some embodiments the outer cover extends ⅓ of the way down the outer surface of the sidewall, in some embodiments ½ down, and in some embodiments ⅔ of the way down. In some embodiments, the water-impermeable outer cover comprises a biodegradable film. In various embodiments, the biodegradable film can be, for example, plastic, wax, or wax-coated paper. In some embodiments the outer cover is only water-resistant or semi-water-resistant, and in some embodiments the outer cover comprises paper or fiber-based material. In yet another embodiment, the water-impermeable outer cover is reflective. The reflective material may exhibit specular reflection or diffuse reflection. For example, in one embodiment, the reflective material includes a white surface, which reflects light in a diffuse pattern.

The cover 140 may help to maintain sanitary and healthy surface conditions. More specifically, the cover may mitigate or eliminate evaporation from the open top end 122 of the elongated inner cavity 121 and the top surface 124 of the sidewall 124. This may help to maintain sanitary and healthy surface conditions in at least two ways. First, vapor evaporation of nutrient solution causes algae development and salt buildup. Second, when plants have grown to develop a canopy, vapor evaporation saturates a micro climate within the canopy, for example up to 100% humidity. Both of these surface conditions can interfere with a plant's healthy development. By reducing or eliminating vapor evaporation and, in one embodiment, light exposure at the plug's top surface, the cover 140 may prevent these unhealthy surface conditions and promotes a more sanitary and healthy environment.

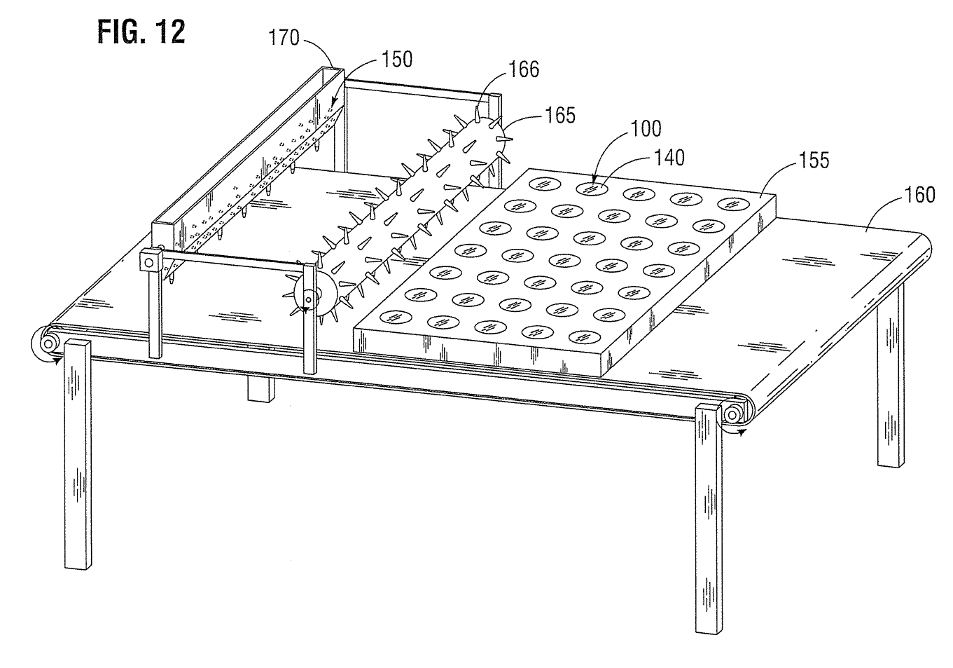

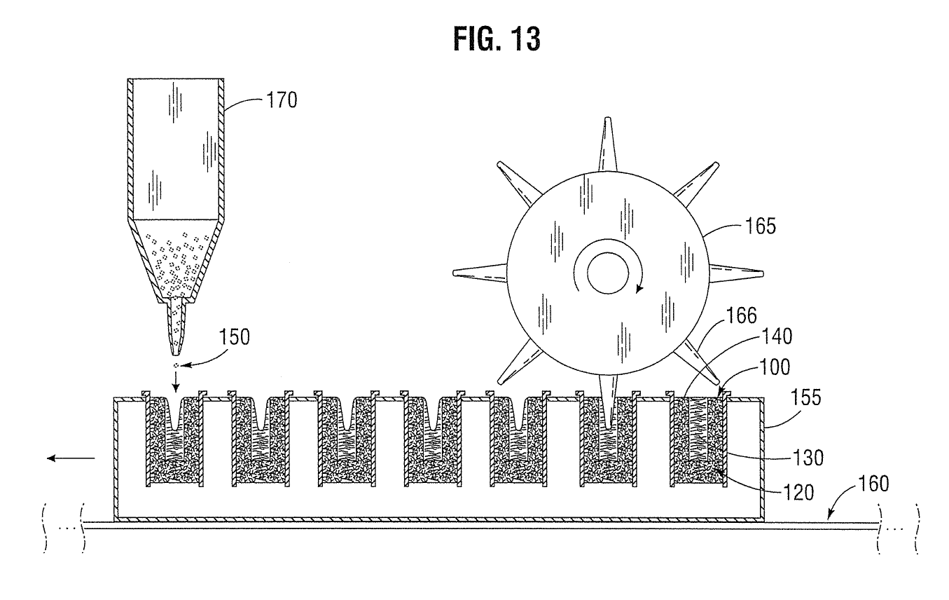

With reference now to FIGS. 11-13, in some embodiments the water-impermeable cover 140 extends down an outer surface 125 of the sidewall 120, which may provide additional rigidity, making the plug 100 better suited to automated planting and processing. For example, in an automated seeding process, the plug 100 can be added to a plug tray 155, which is placed onto an advancement belt 160 and advanced toward a roller dibbler 165. As the plug 100 passes under the roller dibbler 165, dibbler pins 166 make a hole in the cover 140 and growing substrate 130. After passing the dibbler, the plug will pass under an automated seeding portion 170, which will drop a seed 150 into the hole in the growing substrate 130. The cover and the second growing medium surrounding the growing substrate 130 provide structural rigidity to help the plug 100 maintain its shape in such an automated dibbling and seeding process.

It should be appreciated from the foregoing description that some embodiments in accordance with the present invention may provide a dual-media horticultural plug that encourages directed root development; exhibits reduced evaporation, algae development, and salt buildup; and maintains a sterile environment and a consistent and uniform shape throughout all stages of automated processing. For some or all of these reasons, the systems described herein may be suitable for use with automated seeding machines and other automated farming processes.

Specific methods, devices, and materials are described, although any methods and materials similar or equivalent to those described can be used in the practice or testing of the present embodiment. Unless defined otherwise, all technical and scientific terms used herein have the same meanings as commonly understood by one of ordinary skill in the art to which this embodiment belongs.

Although the invention has been discussed with respect to various embodiments, it should be recognized that the invention comprises the novel and non-obvious claims supported by this disclosure.

What is claimed is:

1. A dual-media horticultural plug comprising:
a base having a substantially continuous bottom surface and a top surface spaced from the bottom surface;
a sidewall extending from the base and forming an elongated inner cavity, the elongated inner cavity having an open top end and being substantially defined by an inner surface of the sidewall and the top surface of the base;
a growing substrate substantially filling the elongated inner cavity; and
wherein the outer cover extends over a top surface of the sidewall and down an outer surface of the sidewall toward the base, leaving the bottom surface of the base substantially uncovered;
wherein the growing substrate comprises a first growing medium having a first water holding capacity;
wherein at least one of the base and the sidewall comprises a second growing medium having a second water holding capacity; and
wherein the first water holding capacity of the first growing medium is greater than the second water holding capacity of the second growing medium.

2. The dual-media horticultural plug of claim 1, wherein the first water holding capacity is at least about 70% by volume.

3. The dual-media horticultural plug of claim 2, wherein the second water holding capacity is no more than about 30% by volume.

4. The dual-media horticultural plug of claim 1, wherein the first growing medium comprises capillary pores.

5. The dual-media horticultural plug of claim 4 wherein the second growing medium comprises non-capillary pores.

6. The dual-media horticultural plug of claim 5, wherein the first growing medium has a first bulk density and the second growing medium has a second bulk density, wherein the first bulk density of the first growing medium is greater than the second bulk density of the second growing medium.

7. The dual-media horticultural plug of claim 6, wherein the first bulk density is from about 0.1 g/cm³ to about 0.6 g/cm³.

8. The dual-media horticultural plug of claim 7, wherein the second bulk density is from about 0.01 g/cm³ to about 0.1 g/cm³.

9. The dual-media horticultural plug of claim 6, wherein the first growing medium is selected from the group consisting of coconut coir pith and reticulated foam.

10. The dual-media horticultural plug of claim 9, wherein the first growing medium comprises coconut coir pith.

11. The dual-media horticultural plug of claim 9, wherein the first growing medium comprises reticulated foam.

12. The dual-media horticultural plug of claim 11, wherein the first growing medium comprises reticulated foam having a porosity from about 10 to about 20 pores per inch.

13. The dual-media horticultural plug of claim 9, wherein the second growing medium is selected from the group consisting of coconut coir fiber and reticulated foam.

14. The dual-media horticultural plug of claim 13, wherein the second growing medium comprises coconut coir fiber.

15. The dual-media horticultural plug of claim 13, wherein the second growing medium comprises reticulated foam.

16. The dual-media horticultural plug of claim 12, wherein the second growing medium comprises reticulated foam having a porosity of at least about 100 pores per inch.

17. The dual-media horticultural plug of claim 13, wherein the elongated inner cavity extends from about 75% to about 95% of a depth defined between the top surface of the sidewall and the bottom surface of the base.

18. The dual-media horticultural plug of claim 17, wherein the elongated inner cavity extends from about 15% to about 50% of a width defined by a perimeter of the sidewall.

19. The dual-media horticultural plug of claim 1, further comprising a water-impermeable outer cover substantially covering the open top end of the elongated inner cavity.

20. The dual-media horticultural plug of claim 19, wherein the water-impermeable outer cover comprises a biodegradable film.

21. The dual-media horticultural plug of claim 19, wherein the water-impermeable outer cover is reflective.
